(19) United States
(12) Patent Application Publication
(10) Pub. No.: US 2012/0263592 A1
(43) Pub. Date: Oct. 18, 2012

(54) Method for measuring the wind direction in the wake of a wind turbine rotor

(76) Inventor: Soeren Oemann LIND, Naestved (DK)

(21) Appl. No.: 13/448,427

(22) Filed: Apr. 17, 2012

(30) Foreign Application Priority Data
Apr. 18, 2011 (EP) EP11162814.5

(51) Int. Cl. F03D 11/00; G01P 13/00

(52) U.S. Cl. 416/61; 73/170.01

(57) ABSTRACT

A method for measuring the wind direction signal of a wind turbine is described. The wind direction signal is measured in the wake of a wind turbine rotor. The measured wind direction signal is sorted using at least one sorting parameter. The sorted wind direction signal can be optimised using at least one optimising parameter.

### CROSS REFERENCE TO RELATED APPLICATIONS

This application claims priority of European Patent Office application No. 11162814.5 EP filed Apr. 18, 2011, which is incorporated by reference herein in its entirety.

### FIELD OF INVENTION

The present invention relates to a method for measuring the wind direction and to a wind turbine.

### BACKGROUND OF INVENTION

The wind vane controlling or measuring the yaw direction of the nacelle and rotor of an up-wind wind turbine is normally positioned on the nacelle behind the rotor. The flow disturbance from the rotor, will impact the reading from the wind vane, and give a biased measurement of the wind direction resulting in a yaw error. The yaw error is the phenomenon where the turbine is not pointing into the wind, resulting in the wind direction is not perpendicular on the rotor plane.

To minimize the problem, the wind vane is normally mounted in the position that is considered to have only minor disturbed inflow.

A more advanced method to measure the wind direction is to have instrumentation in front of the rotor. By doing so, the instrumentation has free inflow, and the wake from rotor disk is avoided. Also pressure sensors mounted on the spinner or a surface in front of the turbine can be used, in order to measure the wind direction. However both types have the disadvantage, that the costs are higher than by using the classical nacelle positioned wind vane. For that reason the nacelle positioned wind vane is still the most used solution.

The wind vane can be of either mechanical or sonic type or for that matter any other types. Generally, a spinner anemometer using pressure sensors mounted on the spinner in the front of the rotor is known from the art. Moreover, classical wind vanes and anemometers mounted on a rod in front of the spinner are known.

### SUMMARY OF INVENTION

It is a first objective of the present invention to provide an improved method for measuring the wind direction in the wake of a wind turbine rotor. It is a second objective of the present invention to provide an advantageous wind turbine.

The first objective is solved by a method for measuring the wind direction and the second objective is solved by a wind turbine as claimed in the independent claims. The depending claims define further developments of the present invention.

The inventive method for measuring the wind direction comprises the steps of measuring the wind direction in the wake of a wind turbine rotor, and sorting the obtained wind direction signal using at least one sorting parameter. For example, the wind direction can be measured by a means which is located in the wake of the rotor. The means for measuring the wind direction can preferably be located on a nacelle of the wind turbine. Advantageously, a wind vane may be used as means for measuring the wind direction.

The present invention has the advantage, that the yaw error of a rotor of a wind turbine can be minimized. This can be obtained by improving the measured wind direction signal. The advantage by the using the yaw error is improving the electrical production, and minimizing the loads on the construction. Consequently, the economical return is increased and the components costs are reduced.

The wind direction can be measured as a function of a sorting parameter and the measured wind direction can be sorted depending on the sorting parameter. For instance, the wind direction can be measured as a function of the azimuth angle of the rotor. The obtained wind direction signal can then be sorted depending on the azimuth angle of the rotor.

Preferably, the wind direction signal can be sorted depending on a signal which indicates periods, for example time periods, with disturbed air flow. The air flow at the measuring position can be disturbed, for example, by passing wind turbine rotor blades when the rotor is in operation.

The rotor azimuth angle and/or the rotation speed of the rotor and/or a signal of a gravity sensor (G-sensor) and/or a signal of a load sensor can be used as sorting parameter. The gravity sensor and/or the load sensor may be located at a rotor blade. In other words, the rotor azimuth angle and/or the rotation speed of the rotor and/or the signal of a gravity sensor, for example located at a rotor blade, and/or a signal of a load sensor, for example being located on a rotor blade, can be measured for sorting the measured a wind direction signal. Moreover, the wind direction signal can be sorted by means of a yaw controller.

Generally, the wind direction signal can instantly and/or continuously be sorted. This has the advantage, that a possible time delay between the measurement and obtaining an improved result can be reduced.

Preferably, the wind direction signal can be sorted by picking out or removing specific wind direction signals depending on the at least one sorting parameter. For example, the wind direction signals at specific rotor azimuth degrees, which may for instance correspond to a rotor blade passing through the air flow towards the measuring position, may be removed. This has the advantage that the signals disturbed by the rotor blades may be removed and only the signals corresponding to an undisturbed air flow can be picked out.

Moreover, the sorted signal can be further optimized using at least one optimizing parameter. This further improves the obtained signal and may reduce the yaw error.

For example, a wind speed signal and/or a power signal and/or a pitch angle signal and/or a signal of a load cell may be used as optimizing parameter. A wind speed signal and/or a power signal and/or a pitch angle signal and/or a signal of a load cell can be measured for optimizing the sorted wind direction signal.

The sorted wind vane signal may be optimized using e.g. a measured wind speed to indicate whether the sorted wind vane signal should be corrected. This could be done in the yaw controller by a look-up table for e.g. addition, subtraction, multiplication and/or division of a specific look-up number in relation to the wind speed (optimizing parameter) and the rotor azimuth signal (sorting parameter) and the wind vane signal. Generally, the sorted signal can be optimized by using a look-up table.

The inventive wind turbine comprises a rotor and a means for measuring the wind direction. The means for measuring the wind direction is located in the wake of the rotor. The wind turbine further comprises at least one means for sorting the measured wind direction signals. This has the advantage, that an improved wind direction signal can be obtained, which only represents the undisturbed air flow direction.

Furthermore, the wind turbine may comprise at least one means for optimizing the sorted signal. This allows for a further improvement of the obtained wind direction signal. Especially by using one or more sensors for measuring at least one optimizing parameter from the turbine, it is possible to have a variable part of the wind direction signal or wind vane signal removed, based on the operational conditions.

The wind turbine may comprise a wind vane as means for measuring the wind direction. Moreover, the wind turbine may comprise a yaw controller which comprises the means for sorting the measuring direction signals and/or the means for optimizing the sorted signal. For example, the means for sorting the measured wind direction signal may comprise a gravity sensor and/or a load sensor. The gravity sensor and/or the load sensor may preferably be located on a wind turbine rotor blade. Moreover, the means for optimizing the sorted signal may comprise a load cell. The load cell may preferably be located on the wind turbine rotor blade.

By means of the present invention the yaw error of a rotor of a wind turbine can be minimized by improving a wind direction signal, for example a wind vane signal, by using one or more sensor signals to sort the wind direction signal (sorting parameter) and/or in combination with one or more optimizing sensor signals (optimizing parameter).

### BRIEF DESCRIPTION OF THE DRAWINGS

Further features, properties and advantages of the present invention will become clear from the following description of an embodiment in conjunction with the accompanying drawings. The mentioned features are advantageous separate or in any combination with each other.

FIG. 1 schematically shows a wind turbine.

FIG. 2 schematically shows part of a wind turbine in a perspective view.

FIG. 3 schematically shows the wind direction measured by a wind vane as a function of the rotor azimuth angle.

### DETAILED DESCRIPTION OF INVENTION

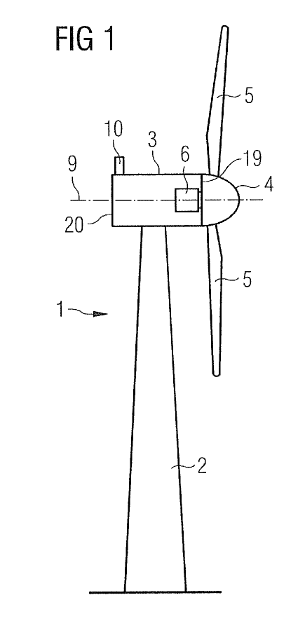

An embodiment of the present invention will now be described with reference to FIGS. 1 to 3.

FIG. 1 schematically shows a wind turbine 1. The wind turbine 1 comprises a tower 2, a nacelle 3 and a rotor or hub 4. The nacelle 3 is located on top of the tower 2. The hub 4 comprises a number of wind turbine blades 5. The rotor or hub 4 is mounted to the nacelle 3. Moreover, the rotor 4 is pivot-mounted such that it is able to rotate about a rotation axis 9. A generator 6 is located inside the nacelle 3. The wind turbine 1 may be a direct drive wind turbine.

The nacelle 3 comprises a near side 19 facing the rotor 4 and a far side 20 opposite to the rotor 4. A wind vane 10 is located on top of the nacelle, preferably close to the far side 20.

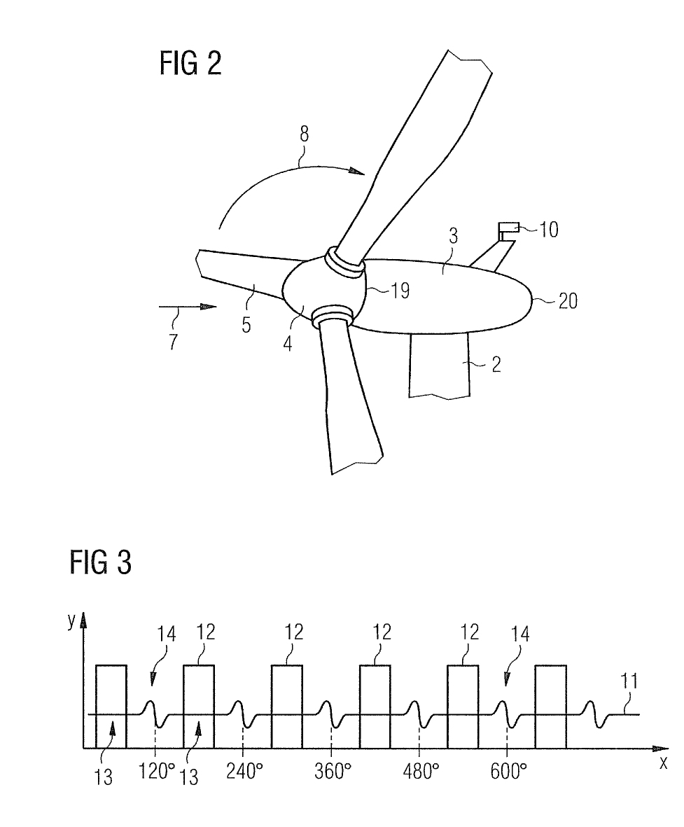

FIG. 2 schematically shows part of a wind turbine 1 in a perspective view. The wind direction is indicated by an arrow 7. The rotation direction of the rotor 4 is indicated by an arrow 8. The wind vane 10 which is used for measuring the wind direction, for example for controlling or calculating the yaw angle, is located in the wake of the rotor 4. This means, that the air flow at first passes the rotor 4 before it reaches the wind vane 10. The air flow arriving at the wind vane 10 is typically disturbed by the influence of the rotor blades 5.

FIG. 3 schematically shows the wind direction measured by the wind vane 10 as a function of the azimuth angle of the rotor 4. In FIG. 3 the x-axis indicates the rotor azimuth angle. The y-axis indicates the measured wind direction. The measured wind direction signals are indicated by reference numeral 11. The measured curve 11 shows portions 12, where the measured wind direction is nearly constant for at least one rotor revolution. These portions 12 represent an undisturbed air flow. This means, that the wind direction which is measured at specific rotor azimuth angle portions represents the wind direction which is also present in the environment of the wind turbine 1. This wind direction is not influenced by the rotor blades 5.

In the present embodiment the three-bladed rotor 4 causes a disturbance by every blade passage at every 120 degrees of rotation. In FIG. 3 at the rotor azimuth angles 120°, 240°, 360° and so forth a rotor blade 5 is passing the wind vane 10 and disturbs the air flow towards the wind vane 10. The measured wind direction in the rotor azimuth angle region around these angles corresponding to a blade passing 14 shows a rapidly changing signal. These signals do not correspond to the real wind direction in the environment of the wind turbine and are not capable for further yaw angle calculations or yaw controlling.

The disturbed measurement signals 14 are removed and the undisturbed measurement signals 13 are picked out for further calculations. Since the wind flow measured by the wind vane 10 is disturbed at every blade passage, the rotor azimuth signal (rotor angle) can be used for sorting the instantly and continuously stored time/history wind vane signal. The wind vane signal can instantly and continuously be sorted by picking out or removing specific wind vane signals at specific rotor azimuth degrees, as for example shown in FIG. 3. This may be done directly by a program in a yaw controller controlling the yaw angle of the rotor 4 and the nacelle 3 of the wind turbine 1. The sorted wind vane signal may further be optimized using e.g. a measured wind speed to indicate whether the sorted wind vane signal should be corrected. This could be done in the yaw controller by a look-up table for e.g. addition, subtraction, multiplication and/or division of a specific look-up number in relation to the wind speed (optimizing parameter) and the rotor azimuth signal (sorting parameter) and the wind vane signal.

Removing a part of the yaw signal or the wind direction signal can be obtained in various ways. The below table shows different options:

| Primary measured | | |
|---|---|---|
| parameter | Sorting parameter | Optimizing parameter |
| Wind Direction | Rotor azimuth | Wind Speed |
| | RPM + signal analysis | Power |
| | G-sensor at the rotor | Pitch angle |
| | Load sensor on the blade | Load cell on blade |
| | Other signals that | Other signals that |
| | directly or indirectly | directly or indirectly |
| | can be used for removing | can optimize the |
| | time periods with | sorting parameter. |
| | disturbed airflow. | |

The wind direction as primary measured parameter can be sorted by a sorting parameter. Generally every signal that directly or indirectly can be used for removing periods with disturbed air flow can be use as sorting parameter. For example, the rotor azimuth angle, the rotation of the rotor per minute and a further signal analysis, a signal of a gravity sensor at the rotor 4 or the signal of a load sensor on the blade 5 can be used as sorting parameter.

Moreover, the primary method and sorted parameter or signal can further be optimized by means of an optimizing parameter. Generally every signal that directly or indirectly can optimize the sorting parameter is capable for being used as optimizing parameter. For example, the wind speed, the power, for instance the power of the rotor or the power of a generator, the pitch angle or a signal of a load cell, for example located on a blade 5, can be used as optimizing parameter. The optimizing parameter can for example be obtained by means of one or more sensors from the turbine. Using an optimizing parameter, for example from an additional sensor, makes it possible to have a variable part of the primary measured wind vane signal or of the sorted wind vane signal removed, for instance based on the operational conditions.

Generally, one or a number of the previously mentioned sorting parameters can be used to sort the primary measured wind direction. Furthermore, one or a number of the mentioned optimizing parameters can be used to further optimize the sorted signal.

The present invention uses the classical setup with the wind vane on the nacelle behind the rotor, however improved by using other sensors. Based on information from other sensors, part of the signal from the wind vane can be removed, and by doing so the wind direction reading can be improved and consequently the yaw error can be minimized This improved signal from the wind vane can be used as a signal to the yaw control system.

Using the inventive method and/or the inventive wind turbine makes it possible to obtain a sorted and optimized wind direction signal, which corresponds to the real and undisturbed wind direction in the environment of the wind turbine. This improved signal can be used for yaw angle calculations and allows reducing the yaw error. A reduced yaw error improves the electrical production, minimizes the loads on the construction and increases economical return and reduces the components.

1. A method for measuring a wind direction signal of a wind turbine, comprising:
measuring the wind direction signal in a wake of a wind turbine rotor; and
sorting the measured wind direction signal using a sorting parameter.

2. The method as claimed in claim 1, wherein the measured wind direction signal is sorted depending on a signal which indicates periods with disturbed air flow.

3. The method as claimed in claim 1, wherein the sorting parameter comprises an azimuth angle of the wind turbine rotor, a rotation speed of the wind turbine rotor, a signal of a gravity sensor, or a signal of a load sensor.

4. The method as claimed in claim 1, wherein the measured wind direction signal is instantly and/or continuously sorted.

5. The method as claimed in claim 1, wherein the measured wind direction signal is sorted by picking out or removing a specific wind direction signal depending on the sorting parameter.

6. The method as claimed in claim 1, wherein the wind direction signal is measured as a function of an azimuth angle of the wind turbine rotor and the measured wind direction signal is sorted depending on the azimuth angle of the wind turbine rotor.

7. The method as claimed in claim 1, further comprising optimising the sorted wind direction signal using an optimising parameter.

8. The method as claimed in claim 7, wherein the optimising parameter comprises a wind speed signal, a power signal, a pitch angle signal, or a load cell signal.

9. The method as claimed in claim 7, wherein the sorted wind direction signal is optimized using a look-up table.

10. A wind turbine, comprising:
a rotor;
a means for measuring a wind direction signal in a wake of the rotor; and
a means for sorting the measured wind direction signal.

11. The wind turbine as claimed in claim 10, further comprising a wind vane comprising the means for measuring the wind direction signal.

12. The wind turbine as claimed in claim 10, wherein the means for sorting the measured wind direction signals comprises a gravity sensor and/or a load sensor.

13. The wind turbine as claimed in claim 10, further comprising a means for optimising the sorted wind direction signal.

14. The wind turbine as claimed in claim 13, further comprising a yaw controller comprising the means for sorting the measured wind direction signal and/or the means for optimising the sorted wind direction signal.

15. The wind turbine as claimed in claim 13, wherein the means for optimising the sorted wind direction signal comprises a load cell.
